(19) United States
(12) Patent Application Publication
(10) Pub. No.: US 2006/0091743 A1
(43) Pub. Date: May 4, 2006

(54) Compact and efficiently cooled fan motor

(75) Inventors: Takuhiro Iwasaki, Okazaki-city (JP); Shinichi Oda, Okazaki-city (JP); Kazuyuki Izumi, Kosai-city (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); ASMO Co., Ltd., Kosai-city (JP)

(21) Appl. No.: 11/257,458

(22) Filed: Oct. 24, 2005

(30) Foreign Application Priority Data
Oct. 28, 2004 (JP) 2004-313966
Oct. 28, 2004 (JP) 2004-313967
Oct. 28, 2004 (JP) 2004-313968

(51) Int. Cl. H02K 9/00; F04B 35/04; F04B 17/00

(52) U.S. Cl. 310/58; 310/156.32; 417/423.8; 417/424.1

(57) ABSTRACT

A rotor magnet 10 and a stator opposing each other are accommodated in a cylindrical fan boss. Groove-like radial ventilation paths are formed on the rotor magnet and fan boss holes are formed in the axial positions corresponding to those of the outer circumferential side fan boss openings. The rotor magnet and the fan-blade driven to rotate by the motor produce an air flow F on the outside of the fan boss. An air flow in the radial ventilation paths flowing to the outer circumferential side is produced and increased by a centrifugal force and a negative pressure generated at the outer circumferential side. The increased air flow is positively discharged from the fan boss holes in the same position in the axial direction as the radial ventilation paths to the outside of the fan boss located at the negative pressure side of the fan-blade.

### BACKGROUND OF THE INVENTION

1. Field of the Invention

The present invention relates to a fan motor.

2. Description of the Related Art

Conventionally, a fan motor used for cooling an engine, etc., of a vehicle is arranged in an engine compartment to which radiant heat from an engine is transferred and therefore, a cooling structure for the fan motor itself is a design problem to be solved. For example, there is a prior art in which, when blades of a fan for moving air rotate, the air flows through the inside of a case of the fan motor to efficiently cool members in the fan motor by sucking and discharging the air from respective ventilation outlets (openings) provided on a front side and a rear side of the case of the fan motor (for example, refer to Patent document 1).

That is, in the prior art, a cylindrical fan boss, which is arranged so as to cover the motor case, supports the blades of the fan and is rotated by a motor, is arranged to cover the front portion of the motor case. In addition, as cooling blades are provided on the inner bottom surface of the fan boss opposing to the motor case, when the fan boss rotates the cooling blades produce a negative pressure behind the cooling blades so as to suck air from the ventilation outlets provided on the motor case and to move the air though the inside of the motor.

In other words, in this prior art, the air sucked from one of the ventilation outlets forms an air flow flowing through an air gap between a rotating armature and a cylindrical magnet stator provided around the rotating armature, in the motor case, and the air flows out to the outside from other ventilation outlets. The respective components of the motor are cooled by the above-mentioned air flow in the motor case.

[Patent document 1] Japanese Utility Model Publication after examination (Kokoku) No. 7-47971

However, in the above-mentioned prior art, as an air flow path in a motor case between a ventilation inlet for air flow-in and a ventilation outlet for air flow-out in the motor case is squeezed by the air gap, the air flow is formed in an unbalanced state (most of the air flows through one side) in the air flow path in the motor case. As a result, the area with which the air is hardly in contact is not cooled. That is, there is a problem that the components of the fan motor were unevenly cooled by the air flow. In addition, the air flow resistance in the air gap is relatively large, and therefore, the flow rate of the ventilation air in the motor case is restricted which is a problem to be solved. In other words, there are cases in which it was difficult to sufficiently cool the members to be cooled.

Moreover, in the above-mentioned prior art, as cooling blades are provided on the inner bottom surface of the fan boss in order to increase the ventilation air flow rate inside the motor, it is necessary to provide a space for accommodating the cooling blades on the inner bottom surface of the fan boss and, therefore, there was a problem that the size of the fan boss was increased.

In addition, in the above-mentioned prior art, the air is discharged to the outside of the motor case from the ventilation outlets open to the upstream of the air flow, produced by the fan-blade, in the positive pressure area located in the rear side of the fan-blade. Therefore, there was a problem that the air flow to the outside of the motor case was disturbed by the pressure produced by the fan-blade and the cooling efficiency of the inside of the motor was degraded.

### SUMMARY OF THE INVENTION

The above-mentioned problem being taken into consideration, the object of the present invention is to provide a fan motor in which the flow rate of the ventilation air within the fan motor is increased and the size of a fan boss is reduced.

Another object of the present invention is to provide a fan motor in which the air flow in the fan motor is prevented from being introduced within a limited area (being in an unbalanced state) and to efficiently cool the respective components of the fan motor.

Still another object of the present invention is to provide a fan motor in which an air-flow from the inside of the fan motor to the outside of the fan motor is smoothly formed and is to increase the cooling efficiency inside the fan motor.

In order to attain the above-mentioned object, in a first aspect of the present invention, a fan motor comprising: a stator (13); a rotor (9, 10) rotating around a rotating shaft (5) in accordance with an electric energy supplied from the outside in a state in which there is an air gap (12) between the rotor (9, 10) and a plane surface (13a) of the stator (13); a fan boss (2) which includes a cylindrical member fixed to the rotating shaft of the rotor so that an axial direction of the fan boss (2) is the same as the direction of the rotating axis of the rotor, the fan boss (2) accommodating the rotor and the stator in an inside of the cylindrical member; a fan-blade (3) integrally provided on an outer side surface (2b) of the cylindrical member of the fan boss and producing an air flow (F) in the axial direction of the rotating shaft (5) according to the rotation of the rotor (9, 10), is characterized in that a rotating center side space (24) is provided around the rotating shaft of the rotor, an outer circumferential side space (23) is provided between the rotor and an inner side surface (2c) of the fan boss at an outer circumferential side of the rotor, and at the same time, in the rotor, radial ventilation paths (11), which open to the rotating center side space at one end thereof and open to the outer circumferential side space (2c) at the other end thereof, respectively, and communicate the rotating center side space with the outer circumferential side space, are formed in parallel to a rotor surface (10a) opposing to the stator via the air gap (12); in that at least a ventilation outlet (4) communicating the outer circumferential side space with the outside of the fan boss is provided in the fan boss; and in that communicating passages (17) directing in the rotating axis direction and communicating the rotating center side space with a positive pressure side of the fan-blade in the air flow is provided in a rotating center side of the stator.

According to this invention, when the motor rotates, that is, when the rotor rotates around the rotating axis with respect to the static stator, the air in the radial ventilation paths formed in the rotor so as to be in parallel to the rotor surface is pushed out into the outer circumferential side space by centrifugal force generated by the rotation of the rotor. An air flow is produced from the outer circumferential side space in the fan boss to the outside of the fan boss through the ventilation outlet communicating the outer circumferential side space in the fan boss and the outside of the fan boss.

The communicating paths are provided axially in the rotating center side of the stator and the communicating paths communicate the space in the rotating center side of the rotor with the positive pressure side of the fan-blade at the outside of the fan boss. Due to this, as air is supplied from the rotating center side space communicating with the outside of the fan boss into the radial grooves, an air flow is always formed from the rotating center side to the outer circumferential side through the radial ventilation paths during rotation of the rotor.

Accordingly, the ventilation air flow rate in the motor case, that is, in the fan boss, is increased by the rotation of the rotor and, at the same time, as this increase of the ventilation air flow rate is carried out by forming the radial ventilation paths in the rotor, and an additional space is not required to be provided in the fan boss, it is possible to reduce the size of the fan boss.

As in a second aspect of the present invention, the radial ventilation path (11) may be a groove having an open side in the sectional shape thereof in which an opening is formed on a surface (10a) of the rotor, or as in a third aspect of the present invention, the radial ventilation path may be a ventilation path having a sectional shape with closed sides.

As in a fourth aspect of the present invention, it is possible to easily produce an air flow from the outer peripheral space in the fan boss to the outside of the fan boss through at least the ventilation outlet when the ventilation outlet is provided on a negative pressure side portion of the fan-blade in the air flow.

As in a fifth aspect of the present invention, the air pushed out from the groove to the outer circumferential side can be exhausted smoothly from at least the ventilation outlet located in the direction of the centrifugal force to the outside of the fan boss by a relatively small air flow resistance, when the opening area of the radial ventilation paths in the axial direction of the rotating shaft is positioned so as to be contained within the opening area of the ventilation outlet, formed on the side surface of the cylindrical member of the fan boss, in the axial direction of the rotating shaft.

As in a sixth aspect of the present invention, it is possible to form the rotor so that a plurality of magnets (100) are adjacently arranged with each other around the rotating shaft and at the same time, each of the radial ventilation paths is formed along a boundary (110) between the adjacent two magnets.

As in a seventh aspect of the present invention, it is possible to form each of the outer circumferential side openings of the radial ventilation paths (11) on the position radially corresponding to the opening of the radial ventilation path at the rotating center side or on a more rear position in the rotation direction with respect to the position of the opening of the radial ventilation path at the rotating center side.

Especially, when the position of the outer circumferential side opening of the radial ventilation path is moved to a more rear position in the rotation direction than the radial position of the opening of the radial ventilation path in the rotating center side, the value of the negative pressure at the outer circumferential side opening is increased so that it is possible to increase the ventilation air flow rate in the radial ventilation paths.

Moreover, as in an eighth aspect of the present invention, it is also possible to form the fan motor so that a heat sink member (19), in which an outer periphery of the heat sink member forms a circumferential air gap between the outer periphery and an inner side surface of the fan boss, is provided on a side (13b) of the stator opposite to the rotor; a plane-like air passage (21) is formed between the heat sink member and the stator and at the same time, a plurality of protrusions (20) are provided so as to extend from the heat sink member to the stator side through the plane-like air passage; and the plane-like air passage communicates with the circumferential air gap in the outer periphery and with the axial communicating passages (17) of the stator (13) in the rotating center side space.

As a result, it is possible to introduce air from the outside of the positive pressure side into the protrusions of the heat sink member located in the plane-like air passages by the air flow formed by the groove of the rotor due to the rotation of the rotor and it is possible to efficiently cool the heat sink member.

In a ninth aspect of the present invention, a fan motor comprising: a stator (13) comprising armature coils (14); a rotor (9, 10) opposing to the stator via an air gap (12) formed in a radial direction and rotating around a rotating shaft (5) in accordance with an electric energy supplied from the outside; a fan boss (2) which is a cylindrical member fixed to the rotating shaft of the rotor so that a an axial direction of the fan boss (2) is the same as the direction of the rotating axis of the rotor, the fan boss (2) accommodating the rotor and the stator in the inside of the cylindrical member; a fan-blade (3) integrally provided on an outer side surface (2b) of the cylindrical member of the fan boss and producing an air flow (F) in the axial direction of the rotating shaft (5) according to the rotation of the rotor (9, 10), is characterized in that the stator is provided with through holes (16) communicating a first surface (13a), which opposes to the rotor so as to form the air gap, with a second surface (13b) on a side opposite to the rotor; and at least a ventilation outlet (4) communicating the air gap in vicinity of an outer circumferential side of the rotor with the outside of the fan boss is provided on the fan boss.

According to the present invention, as the through holes which communicate the first surface opposing to the rotor with the second surface opposing to the first surface are provided in the stator, the through holes act as bypass passages of the air flow in the motor so that the air flowing through the bypass passages flows in the motor to increase the air flow rate in the motor and it is possible to cool the vicinity of the through holes such as the stator area.

As in a tenth aspect of the present invention, at least the ventilation outlet (4) of the fan boss (2) is formed on an area of the fan boss at the upstream side of the fan-blade (3) in the direction of an air flow produced by the fan-blade (3) and therefore, it is possible to produce a strong air flow from the inside of the fan boss to the outside of the fan boss through the ventilation outlet by a great negative pressure, in the outside of the fan boss, produced by the fan-blade.

In addition, as in an eleventh aspect of the present invention, the openings of the through holes (16) of the stator near the second surface communicate with a downstream area of the fan-blade in the direction of the air flow produced by the fan-blade and therefore, it is possible to increase the air flow rate by causing an air to flow easily into the through holes of the stator.

Further, as in a twelfth aspect of the present invention, it is possible to form each of the armature coils (14) as an empty core coil wound around the through hole (16).

Moreover, as in a thirteenth aspect of the present invention, when the heat sink member (19) is provided near the second surface (13b) of the stator (13), a plane-like air passage (21) is formed between the heat sink member (19) and the second surface and at the same time, a plurality of protrusions (20) are provided so as to protrude to the side of the stator from the heat sink member (19) through the plane-like air passage (21), and the plane-like air passage (21) communicates with a downstream area of the fan-blade (3). Therefore, it is possible to positively impinge the air flowing through the through holes to the heat sink member and it is possible to efficiently cool the heat sink member.

In a fourteenth aspect of the present invention, a fan motor (1) comprising: an electric motor (6) comprising a rotating shaft (5); a fan boss (2) the bottom surface (2a) of which is fixed to the rotating shaft so that an axial center of the fan boss (2) coincides with a rotating axis of the rotating shaft (5), the fan boss (2) accommodating the electric motor in an inside of a cylindrical member of the fan boss (2); a fan-blade (3) integrally provided on an outer side surface of the cylindrical member of the fan boss (2) and producing an air flow (F) in the direction of the rotating axis by rotating together with the fan boss according to the rotation of the electric motor so that the bottom surface (2a) is located at an upstream side in the air flow, is characterized in that at least a ventilation outlet (4) communicating an inside and an outside of the fan boss (2) is provided at an upstream side of the air flow produced by the fan-blade (3) in the outer side surface of the cylindrical member of the fan boss (2).

According to the present invention, when the fan boss is rotated by an electric motor accommodated in the cylindrical fan boss, an air flow is produced from the inside of the fan boss to the outside of the fan boss through the ventilation outlets by a negative pressure formed on the outside of the fan boss where the peripheral velocity of the air flow is high. At least the ventilation outlet is provided in the upstream side of the fan-blade producing an air flow in the rotating axis direction of the electric motor and the fan boss in a state in which the bottom side of the fan boss is located on the upstream side of the air flow and at least the ventilation outlet communicates the inside and the outside of the fan boss. In addition, as the upstream side of the fan-blade in which the ventilation outlet is formed functions as a negative pressure forming area, an air flow from the ventilation outlet to the outside of the fan boss is produced smoothly. Therefore, it is possible to form a smooth air flow in the fan boss as the air smoothly flows from at least the ventilation outlet to the outside of the fan boss.

As in a fifteenth aspect of the present invention, at least the ventilation outlet (4) opens so that the opening length of at least the ventilation outlet (4) is a distance from the bottom surface (2a) to an end portion (42) in the axial direction of the rotating shaft and therefore, it is possible to easily mold the fan boss.

As in a sixteenth aspect of the present invention, at least the ventilation outlet (4) opens so as to include a position of a maximum negative pressure producing portion (P) at the blade negative pressure surface (34) side in a blade root (30) of the fan-blade (3), in the axial direction of the rotating shaft. In this configuration, the value of the negative pressure at the ventilation outlet can be relatively increased and it is possible to make the air flow smoothly from the ventilation outlet.

Further, as in a seventeenth aspect of the present invention, at least the ventilation outlet (4) opens so as to include a maximum negative pressure producing portion (P) at the blade negative pressure surface (34) side in a blade root (30) of the fan-blade (3). In this configuration, the value of the negative pressure at the ventilation outlet can be relatively increased and it is possible to make the air flow smoothly from the ventilation outlet.

The symbols in the parenthesis attached to each means described above indicate a correspondence with the specific means in the embodiments to be described later.

The present invention may be more fully understood from the description of the preferred embodiments of the invention set forth below, together with the accompanying drawings.

### BRIEF DESCRIPTION OF THE DRAWINGS

In the drawings:

FIG. 1A is a top view of a fan boss and a fan-blade of a fan motor in a first embodiment of the present invention.

FIG. 1B is a partial sectional view of FIG. 1A.

FIG. 2 is a sectional view of an inside of a fan boss of the first embodiment.

FIG. 3 is a sectional perspective view of the fan boss of the first embodiment.

FIG. 4 is a perspective view of a rotor magnet of the first embodiment.

FIG. 5 is a front view of a rotor magnet according to other embodiment.

FIG. 6 is a front view of a rotor magnet according to still other embodiment.

FIG. 7 is a sectional side view of a rotor magnet according to other embodiment.

FIG. 8 is a sectional view of an inside of the fan boss of a second embodiment according to the present invention.

FIG. 9 is a sectional perspective view of the fan boss of the second embodiment.

FIG. 10 is a plan view of a stator of the second embodiment.

FIG. 11A is a top view of a fan boss and a fan-blade of a fan motor in a third embodiment of the present invention.

FIG. 11B is a partial sectional view of a fan boss and a fan-blade of a fan motor in FIG. 11A.

FIG. 12 is a partial exploded view of a outer side of the fan boss of the third embodiment.

FIG. 13 is a negative pressure distribution diagram on a blade negative pressure surface of the fan-blade.

### DESCRIPTION OF THE PREFERRED EMBODIMENTS

### First Embodiment

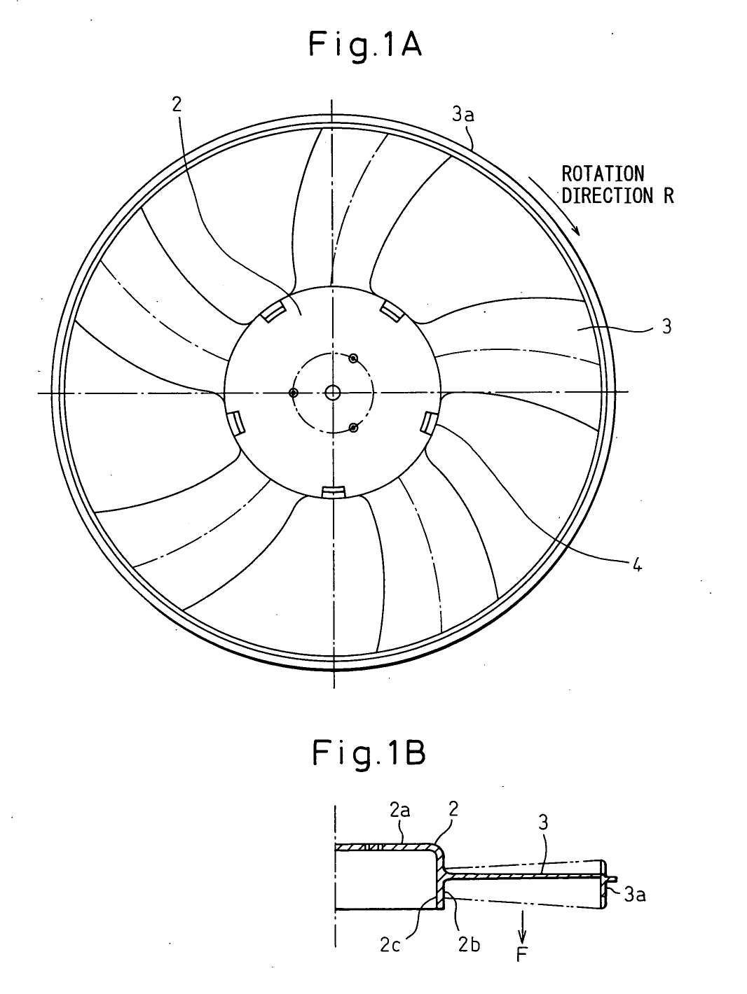

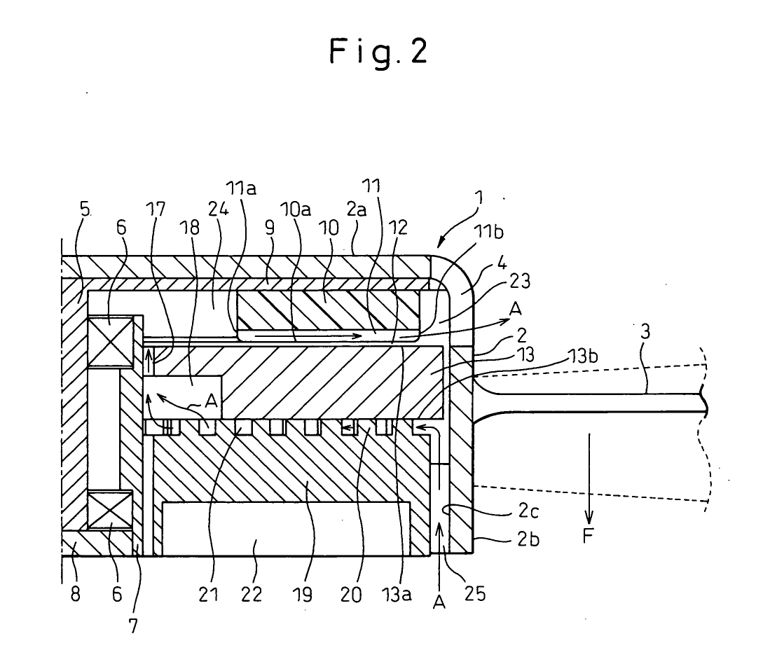

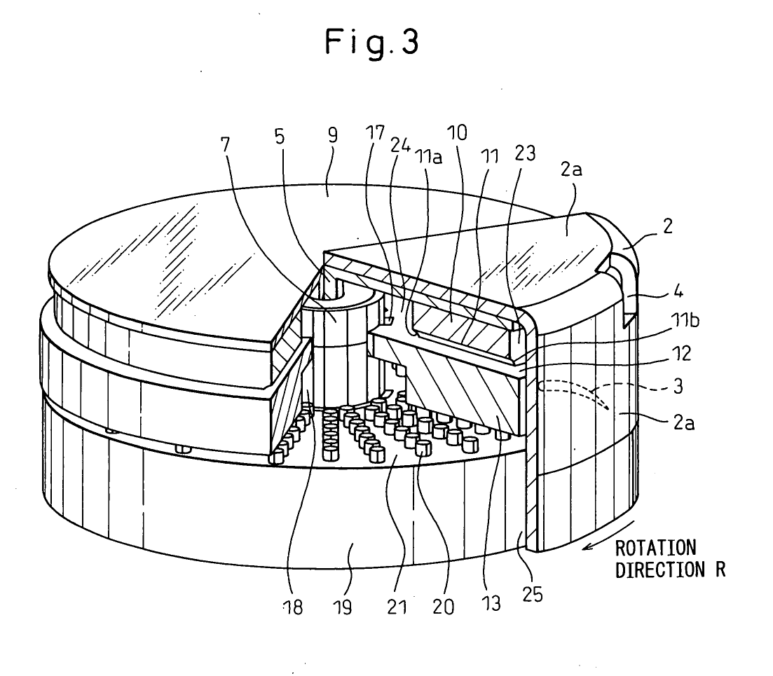

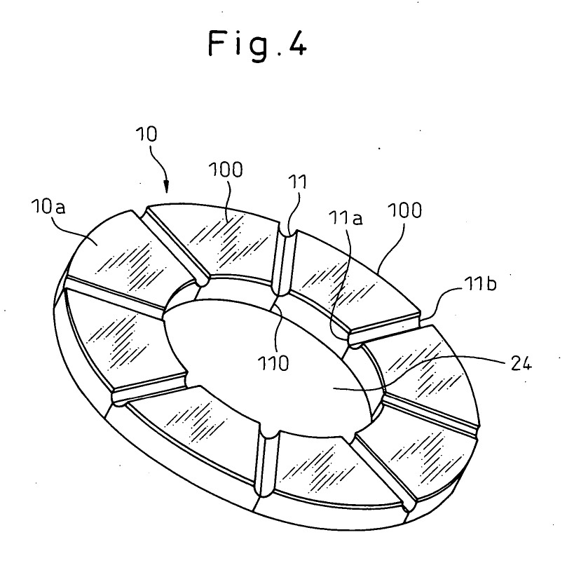

A first embodiment of the present invention is described below with reference to figures. FIG. 1A and FIG. 1B are a top plan view and a cross-sectional view of a fan boss 2 and a fan-blade 3 in a fan motor 1 according to the first embodiment. FIG. 2 is a sectional view of the inside of the fan boss 2 and FIG. 3 is a partially cut-off sectional perspective view of the fan boss 2 without the fan-blade 3. FIG. 4 is a perspective view of a rotary magnet 10.

In the first embodiment of the present invention, the fan boss 2 is formed in a cylindrical shape. A cylindrical member, that is, a portion having a cylindrical shape, accommodates the components of a motor and at the same time, the fan-blade 3 which produces an air flow F in an axial direction of the cylindrical member by the rotation of the fan boss are integrally formed on an outer side face 2b of the cylindrical member. In the present embodiment, the fan-blade 3 has five blades. The blade shape of the fan-blade 3 at the top end thereof is maintained by a retaining ring 3a. The section view of the fan-blade 3 shown in FIG. 1B is taken along the center line of the blade in the width direction thereof (as shown by an alternate long and short dash line in FIG. 1A).

By the rotation of the fan-blade 3, a negative pressure is produced at the upstream side of the fan-blade 3 and a positive pressure is produced at the downstream side of the fan-blade 3 so that an air flow F is produced in the downward direction in FIG. 1B. Fan boss holes 4 as ventilation outlets for communicating the outside of the fan boss 2 with the inside thereof are provided on the cylindrical outer side surface 2b of the fan boss 2 at the negative pressure side.

The fan boss holes 4 open in a position (area) including the opening positions (opening areas) of radial grooves 11 as ventilation paths in the radial direction of a rotor magnet 10 which is described later, in the direction of the air flow F (the direction of the rotating axis of the motor). In addition, five fan boss holes 4 are provided on respective intermediate positions between the two blades of the fan-blade 3 in the circumferential direction of the fan boss 2 on the outer side surface 2b of the fan boss 2.

According to the configuration, an air is discharged in the outer circumferential direction from the radial ventilation paths 11 in accordance with the rotation of the rotor magnet 10. The discharged air can be efficiently exhausted from the fan boss holes 4 located on the positions in the rotating axis direction same as the opening areas of the radial ventilation paths 11 to the outside of the fan boss 2 in a low pressure loss of an air flow.

The fan boss holes 4 open up to the bottom surface 2a of the fan boss 2 and the openings of the fan boss holes 4 are mainly provided so as to make it easy to draw the fan boss 2 out from a mold during the molding of the fan boss 2.

In the present embodiment, namely an axial gap fixed yolk type motor in which a disk-like permanent magnetic rotor rotates in a state, where the rotor opposes to the armature coils on the stator side, is employed as a motor accommodated in the inside of the fan boss 2.

The bottom portion 2a of the cylindrical member of the fan boss 2 is fixed on a rotor disc 9 by screws, etc. A shaft 5 is integrally formed on a disk-shaped portion of the rotor disc 9 in an orthogonal direction thereof. The shaft 5 is rotatably supported by a cylindrical holder 7 via a bearing 6. In this configuration, the fan boss 2 and the rotor disc 9 can integrally rotate together around the shaft 5, which is a rotating common axis thereof, in the holder 7.

An annular rotor magnet 10 is attached to the rotor disc 9 so that the center of the rotor magnet 10 coincides with the center axis of the shaft 5. The rotor magnet 10, as shown in FIG. 4, is formed by arranging eight poles magnetic plates 100 in the circumferential direction and each of the grooves 11 which opens on a rotor surface 10a is formed as a radial ventilation path on the rotor surface 10a forming an air gap 12 between it and a stator 13, described later, in a radial direction along the boundary 110 between the adjacent magnetic plates 100.

In other words, in the present embodiment, the radial ventilation path 11 has a groove-like shape with an open cross-section and there are eight paths 11 radially projecting toward the outer circumferential side openings 11b open into the outer circumferential side space 23 from the rotating center side openings 11a open into a rotating center side space 24. The cross-sectional shape of the groove 11 is formed in a semi-circular shape, however it may be formed in any other shape such as rectangular or triangular.

The stator is a disc-shaped member attached to the holder 7 and comprises six armature coils (not shown) in the circumferential direction. The surface 13a of the stator 13 at the air gap side is arranged so as to oppose the rotor magnet 10 with the air gap 12 and forms a magnetic circuit.

A plurality of communicating passages 17 in the direction of the rotating axis are provided around the holder 7 in the rotation central area of the stator 13. The axial communicating passages 17 communicate with an annular cavity 18 provided in an opposite side of the surface 13a of the stator 13 at the air gap side. The radial distance of the annular air gap between the outer circumferential side of the stator 13 and the inner side surface 2c of the fan boss 2 provides an air flow resistance larger than that in the communicating passages 17.

A disc-shaped heat sink member 19 is provided to attach to the holder 7 so as to come into contact with the surface 13b of the stator 13 at the side opposite to the rotor magnet 10, via a plurality of protrusions 20. In other words, an air passage 21 having a plane-like area is provided between the heat sink member 19 and the stator 13 and the plurality of protrusions 20 which come into contact with the surface 13b of the stator 13 extend from the heat sink member 19, in the plane-like air passage 21.

Due to this, an air flowing through the plane-like air passage 21 exchanges heat with the protrusions 20 and therefore, it is possible to cool, by air, the stator 13 being in contact with the heat sink member 19 and the protrusions 20. In this configuration, a circuit section 22 of the motor is accommodated in the bottom of the heat sink member 19 (in the lower portion in the FIG. 2) so that it is possible to cool the circuit section 22 by the heat sink member 19.

An annular gap 25 in the circumferential direction is provided between the outer circumferential side of the heat sink member 19 and the inner side surface 2c of the fan boss 2. The annular gap 25 in the circumferential direction opens in the downstream side of the air flow F in the fan motor 1, that is, the positive pressure side, and has a role as the ventilation port of the case of the fan motor 1 at the positive pressure side.

### Second Embodiment

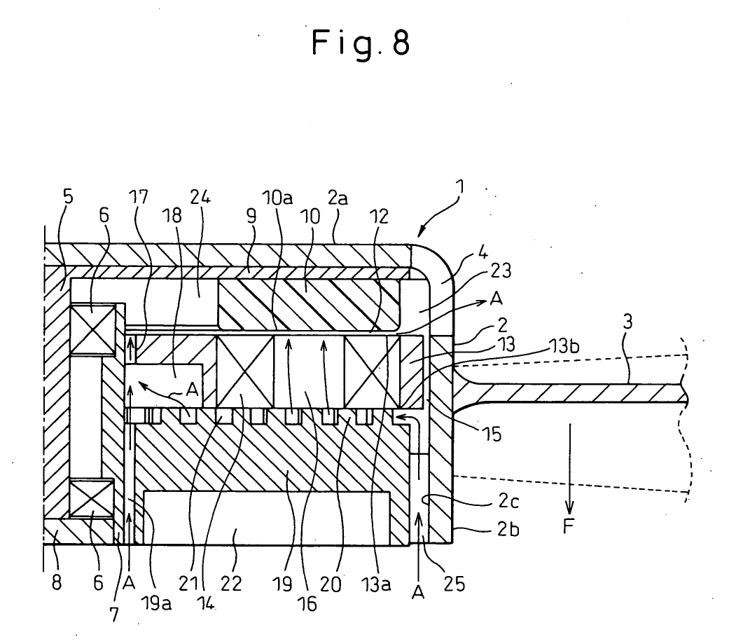

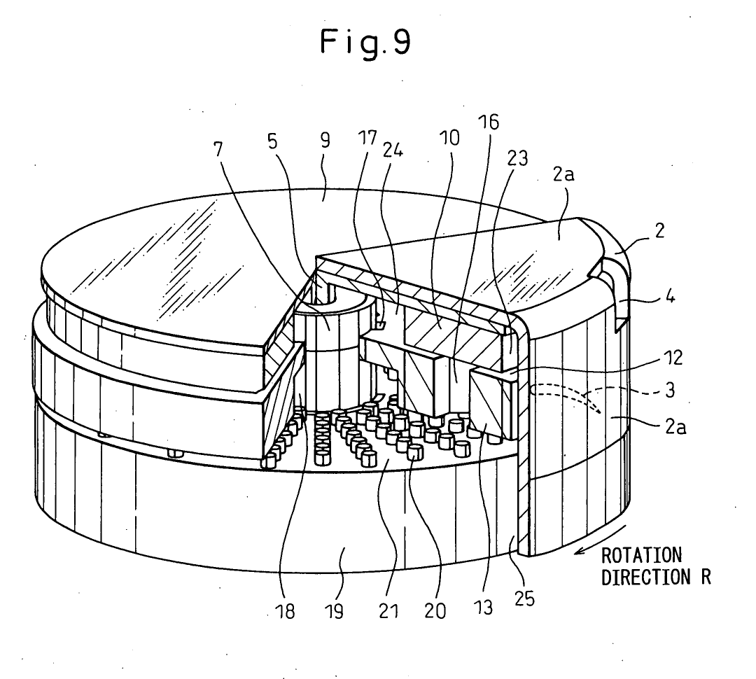

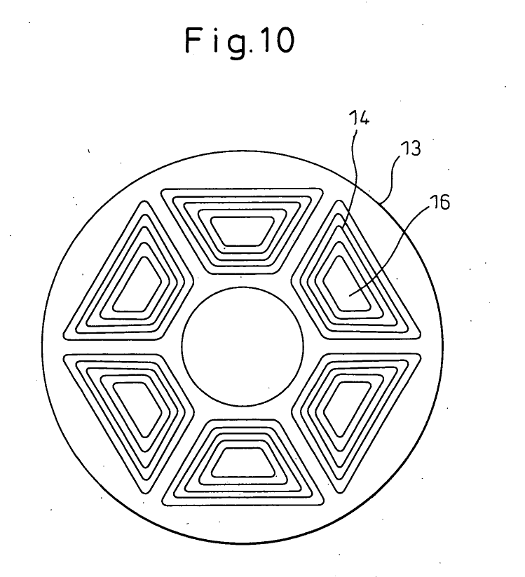

A second embodiment of the present invention is described below with reference to figures. FIG. 1A and FIG. 1B are a top plan view and a cross-sectional view of a fan boss 2 and a fan-blade 3 in a fan motor 1 according to the second present embodiment. FIG. 8 is a sectional view of the inside of the fan boss 2 and FIG. 9 is a partially cut-off sectional perspective view of the fan boss 2 without the fan-blade 3. FIG. 10 is a plan view of a stator 13.

In a first embodiment of the present invention, the fan boss 2 is formed in a cylindrical shape. A cylindrical member, that is, a portion having a cylindrical shape, accommodates the components of a motor and at the same time, the fan-blade 3 which produces an air flow F in an axial direction of the cylindrical member by the rotation of the fan boss is integrally formed on an outer side face 2b of the cylindrical member. In the present embodiment, the fan-blade 3 has five blades. The blade shape of the fan-blade 3 at the top end thereof is maintained by a retaining ring 3a. The sectional view of the fan-blade 3 shown in FIG. 1B is taken along the center line of the blade in the width direction thereof (as shown by an alternate long and short dash line in FIG. 1A).

By the rotation of the fan-blade 3, a negative pressure is produced at the upstream side of the fan-blade 3 and a positive pressure is produced at the downstream side of the fan-blade 3 so that an air flow F is produced in the downward direction in FIG. 1B. Fan boss holes 4 as ventilation outlets for communicating the outside of the fan boss 2 with the inside thereof are provided on the cylindrical outer side surface 2b of the fan boss 2 at the negative pressure side.

The fan boss holes 4 have rectangular shapes and open within the range from the bottom surface 2a of the fan boss 2 to the air gap 12 in the axial direction. In addition, five fan boss holes 4 are provided on respective intermediate positions between the two blades of the fan-blade 3 in the circumferential direction of the fan boss 2, on the outer side surface 2b of the fan boss 2.

As the fan boss hole 4 extends up to the bottom surface 2a of the fan boss 2 it is easy to draw the fan boss 2 out from a mold during molding the fan boss 2.

In the present embodiment, an axial gap fixed yolk type motor, in which a disk-like permanent magnetic rotor rotates in a state where the rotor opposes to the armature coils on the stator side, is employed as a motor accommodated in the inside of the fan boss 2.

The bottom portion 2a of the cylindrical member of the fan boss 2 is fixed on a rotor disc 9 by screws, etc. A shaft 5 is integrally formed on a disk-shaped portion of the rotor disc 9 in an orthogonal direction thereof. The shaft 5 is rotatably supported by a cylindrical holder 7 via a bearing 6. In this configuration, the fan boss 2 and the rotor disc 9 can integrally rotate together around the shaft 5, which is a common rotating axis (rotating co-axis) thereof, in the holder 7.

An annular rotor magnet 10 is attached and fixed to the rotor disc 9 so that the center of the rotor magnet 10 coincides with the center axis of the shaft 5. The rotor magnet 10 comprises eight pole magnetic plates 100 arranged in the circumferential direction.

The stator is a disc-shaped member attached to the holder 7 and comprises six armature coils in the circumferential direction. The surface 13a of the stator 13 at the air gap side is arranged so as to be opposed to the rotor magnet 10 with the air gap 12 and forms a magnetic circuit.

Each of the armature coils 14 is a coil having an empty core portion and is wound in a trapezoidal shape and the empty core portion is formed by a through hole 16. In other words, a through hole 16 opens in a first surface 13a which is located on the side near the air gap 12 of the stator 13 and in a second surface 13b which is opposite to the first surface 13a, respectively, and penetrates through the area between the first surface 13a and the second surface 13b. Accordingly, air can pass through the through holes 16. As the empty core portion is placed on a position near the center of the stator 13 (near the rotating axis), it is possible for air to flow through wide areas of the plane-like air passage 21 described later so that it is possible to more efficiently cool the heat sink member 19.

In the rotating center area of the stator 13, a plurality of communication passages 17 running in the rotating axis direction are provided around the holder 7 so as to be arranged in circumferential direction. The communication passages 17 running in the rotating axis direction are communicated with the first surface 13a near the air gap of the stator 13 and an annular cavity 18 provided on the opposite side thereof. The radial distance of the annular air gap 15 between the outer periphery of the stator 13 and the inner side surface 2c of the fan boss 2 is set so that the air flow (ventilation) resistance thereof is larger than that in the communication passages 17.

In the second surface 13b of the stator 13 near the side opposite to the rotor magnet 10, a disc-shaped heat sink member 19 is provided so as to be rigidly attached to the holder 7 and to come into contact with the second surface 13b via a plurality of protrusions 20. In other words, the plane-shaped air passage 21 is provided between the heat sink member 19 and the stator 13, and a plurality of the protrusions 20 which come into contact with the second surface 13b of the stator 13 protrude from the heat sink member 19 in the plane-shaped air passage 21.

As a result, it is possible to air-cool the stator 13, which is in contact with the heat sink member 19 and the protrusions 20, by using an air which flows through the plane-shaped air passage 21 and effects heat-exchange with the protrusions 20. In a bottom portion of the heat sink member 19 (on the lower side in FIG. 2), a circuit section 22 of the motor is accommodated so that it can be cooled by the heat sink member 19.

An annular air gap 25 in a circumferential direction is provided between the outer periphery of the heat sink member 19 and the inner side surface 2c of the fan boss 2. The circumferential air gap 25 opens in the downstream side of the air flow F of the fan motor 1, that is, a positive pressure side, and corresponds to the positive pressure side ventilation port of the case of the fan motor 1. By the way, a plurality of communicating passages 19a in the rotating axis direction are provided around the holder 7 in the rotating center portion of the heat sink member 19 and air is introduced into the annular cavity 18 from the outside of the fan boss 2 through the communicating passages 19a.

In the first embodiment, the air flow formed outside and inside of the fan boss 2 by rotation of the fan boss 2 will be explained below. (In the second embodiment, the explanation of the air flow is similar to that of the first embodiment.)

Electrical energy is given to the fan motor 1 from the outside and an electromagnetic force is formed between the stator 13 and the rotor magnet 10. The electromagnetic force then rotates the rotor (rotor magnet 10 and rotor disc 9) and as a result, an air flow F is produced by the fan-blade 3.

The air flow F is produced in the rotating axis direction on the cylindrical side surface of the fan boss 2. In this condition, a negative pressure state (a negative pressure side) is produced on the air flow upstream side of the fan-blade 3 and a pressure difference (a negative pressure condition at the outside) in the radial direction having the magnitude corresponding to the rotation speed (peripheral velocity) of the fan boss 2 is produced in the fan boss holes 4. Due to this pressure difference, an air flow is produced by pushing the air outside the fan boss 2 through the fan boss holes 4 from the outer circumferential side space 23 in the fan boss 2.

On the other hand, the centrifugal force and the negative pressure at the outer circumferential side opening 11b with respect to the rotating center side opening 11a act on the air within the radial grooves 11 by the rotation of the rotor magnet 10 so that an air flow from the rotating center side opening 11a to the outer circumferential side opening 11b is generated.

In other words, the radial grooves 11 formed on the rotor magnet 10 function as a pump to pump air in the radially outer direction. In addition, as it has a groove-like shape, an additional space is not required to be formed and the air resistance of the rotation of the rotor magnet 10 can be reduced. Moreover, as each of the grooves 11 is formed along the boundary between the adjacent magnet plates 100 it is easy to fabricate the respective magnetic plates 100.

The rotating center side space 24 to which the rotating center side openings 11a of the rotor magnet 10 open is formed to draw an air through the axial communicating passages 17 of the stator 13, communicating with the rotating center side space 24, from the annular cavity 18 located at the upstream thereof, the plane-shaped air passage 21 and the circumferential air gap 25 as the pressure of the rotating center side space 24 is lowered.

Specially, air is pushed into the circumferential air gap 25, which acts as a positive pressure side ventilation port, from the outside of the fan motor 1 which is located in a downstream side of the air flow F and is in a positive pressure state.

As described above, the ventilation air flow rate in the fan boss 2 is increased by the rotation of the radial grooves 11 which are the radial ventilation paths formed in the rotor magnet 10 and, as the increased air flow is produced from the inside to the outside of the fan boss 2 in the direction indicated by the arrow A in FIG. 2, it is possible to efficiently cool the heat sink member 19 by an air flowing around the protrusions 20 of the heat sink member 19, in the fan boss 2. As a result, it is possible to cool the necessary portions of the motor by heat conduction in the heat sink member 19.

In the second embodiment, the air flow resistance of the annular air clearance 15 is relatively large but, on other hand, the through holes 16 of the stator 13 communicate with the air gap 12. Therefore, an air flow into the outer circumferential space 23 is mainly supplied from the air gap and the through holes 16. On the other hand, an air flows into the air gap 12 through the axial communication passages 17 of the stator 13 from the upstream annular cavity 18, the plane-shaped air passage 21 and the circumferential air gap 25.

As described above, in the second embodiment, an air flow is produced from the inside to the outside of the fan boss 2 by the rotation of the fan boss 2 (that is, the fan-blade 3) in the direction indicated by the arrow A in FIG. 8. In other words, the air evenly flows in the fan boss 2 and it is possible to efficiently cool the heat sink member 19 by the air flowing around the protrusions 20 of the heat sink member 19 in the fan boss 2. As a result, it is possible to cool the necessary portions of the motor by heat conduction in the heat sink member 19. In addition, as the air can positively flow into the through holes 16 it is possible to efficiently cool the armature coils 14 of the stator 13.

### Third Embodiment

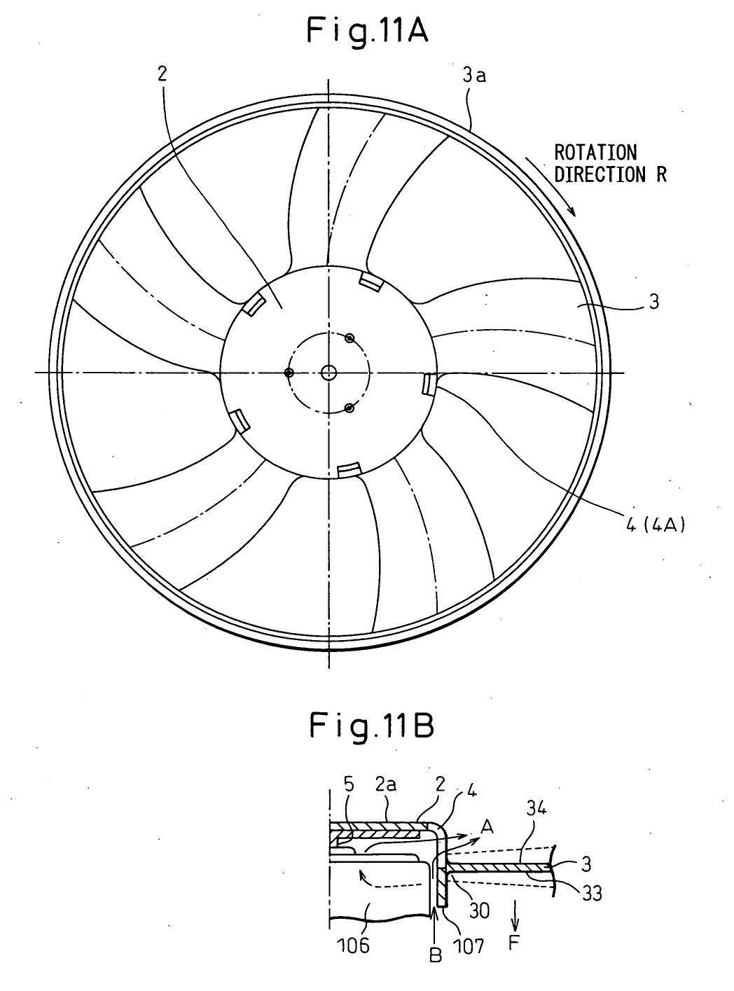

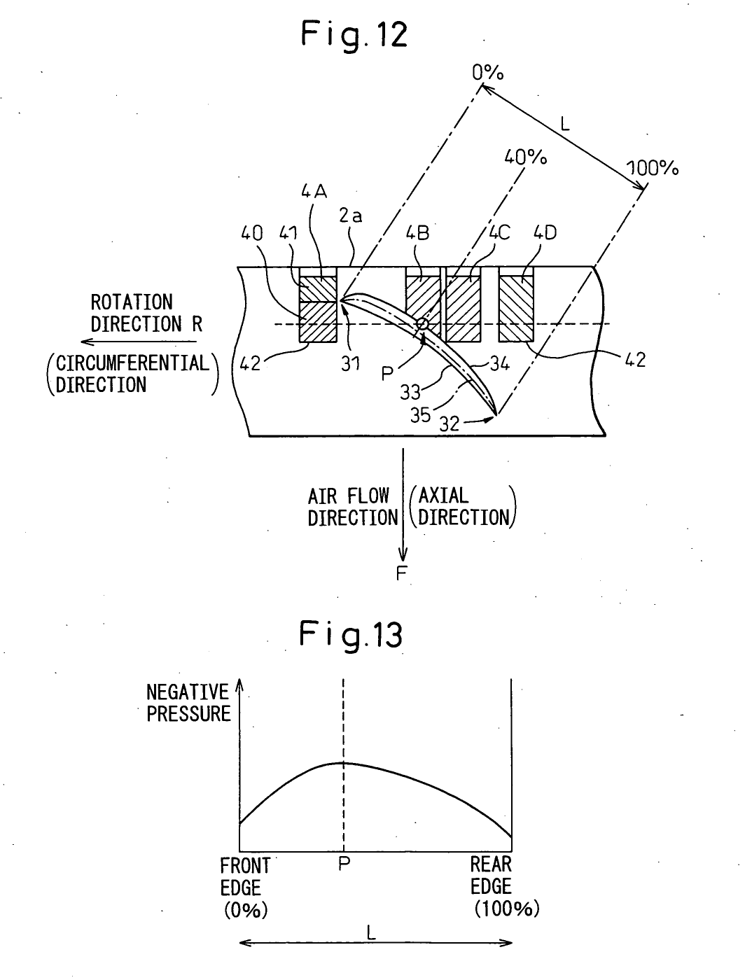

A third embodiment of the present invention will be explained below with reference to the figures. FIG. 11A and FIG. 11B are a top plan view and a sectional view of a fan boss 2 and a fan-blade 3 in a fan motor 1 according to the present embodiment. FIG. 12 is an exploded view from the side direction of the fan boss 2.

In the present embodiment, the fan boss 2 has a cylindrical shape comprising a bottom surface 2a . A front portion of an electric motor 106 is received in the cylindrical member of the fan boss 2, and a shaft 5 that is an output shaft (rotating shaft) of the electric motor 106 and the bottom surface 2a of the fan boss 2 are fixed to each other so that each of the rotating axes coincide with each other.

An axial flow type fan-blade 3 for producing an air flow F in the rotating axis direction by the rotation of the fan boss 2 are integrally formed on the outer side surface 2b of the cylinderical member of the fan boss 2. In the present embodiment, the fan-blade 3 has five blades.

The shape of the blades of the fan-blade 3 at the top of the blades is maintained by a retaining ring 3a. The section of the fan-blade 3 in FIG. 11B is shown as being taken along the center line of the blade width (an alternate dot and line in FIG. 11A). Due to the rotation of the fan-blade 3, as a negative pressure state is produced at the upstream side of the fan-blade 3 and a positive pressure state is produced at the downstream side of the fan-blade 3, an air flow F directing to the lower side (downward direction) in the figure is formed.

At the negative pressure side of the cylindrical outer side surface of the fan boss 2, five fan boss holes 4, as ventilation outlets communicating the outside and the inside of the fan boss 2 with each other, are provided for the five blades of the fan-blade 3, respectively, at the specific positions described later.

FIG. 12 is a partially exploded view of the cylindrical outer side surface of the fan boss 2 and shows the position relationship of the fan-blade 3 and the fan boss holes 4A to 4D in the blade root 30 of a fan-blade 3. The blade root 30 denotes a connecting portion between the fan-blade 3 and the fan boss 2. The front edge 31 and the rear edge 32 of the blade denote the front side and the rear side in the rotating direction of the fan boss 2 of the fan-blade 3, respectively. In addition, the surface of the fan-blade 3 at the front face side in the rotating direction of the fan boss 2 indicates the blade positive pressure surface 33 and the surface of the fan-blade 3 at the back face side in the rotating direction of the fan boss 2 indicates the blade negative pressure surface 34.

In the present invention, the positions of the fan boss holes 4, as ventilation outlets, are set at or near the position P at which the maximum negative pressure is produced by the fan-blade 3. Therefore, the pressure inclination of the fan blade hole 4 is such that the pressure increases from the inside to the outside of the fan boss 2, so that a strong air flow, which passes through the fan boss hole 4, is produced.

In other words, as shown in the distribution diagram of the negative pressure on the blade negative pressure surface 34 at the blade root 30 of the fan-blade 3 with respect to the blade length L direction in FIG. 13, on the blade negative pressure-surface 34, the negative pressure becomes maximum at the position P which is a few tens of % of the blade length L from the blade front edge. The blade length L is the length taken along the blade center line of the fan-blade 3. In the present embodiment, the maximum negative pressure producing portion P occurs at a position 40% of the blade length L from the blade front edge.

Accordingly, it is possible to form the opening of the fan boss hole 4 so as to include the maximum negative pressure producing portion P (reference number 4B in FIG. 12). The fan boss hole 4B opens in a trapezoid-like shape which is included in a area from the bottom surface 2a of the fan boss 2 to the blade negative pressure surface 34 of the fan-blade 3 in the axial direction.

On the other hand, as the maximum negative pressure producing portion P is located on a portion on the blade negative pressure surface 34 of the fan-blade 3, from the view of ensuring the strength of the fan-blade 3, the size of the opening area is limited. As the flow rate of the air flowing through the fan boss holes 4 is the product of the negative pressure and the opening area, it is preferable to form the fan boss holes 4 in a position so that the fan boss holes 4 are moved along the rotating direction R within a range where the negative pressure is formed by the fan-blade 3, in order to obtain an air flow rate equal to or larger than the case in which an air flows through the fan boss hole 4B.

To be specific, it can open so as to include the position of the maximum negative pressure producing portion P in the rotation axis direction within an area between the blade front edge 31 and the blade rear edge 32, that is, as indicated by the reference numerals 4A, 4C and 4D in FIG. 12.

The fan boss hole 4A connects an opening 40 and the bottom surface 2a of the fan boss 2 using the opening 41 so that the fan boss 2 can be easily drawn from a mold during the molding of the fan boss 2. The opening 40 is formed to be adjacent to the blade front edge 31 and to include the position of the maximum negative pressure producing portion P in the axial direction. Therefore, the fan boss hole 4A has a rectangular form in which the opening length is formed between the bottom surface 2a and the end 42 of the opening 40 and can have a sufficient opening area.

Furthermore, the fan boss hole 4D is formed so that the fan boss hole 4A is moved in a rotation direction R to a position behind the blade negative pressure surface 34 of the fan-blade 3 and so that the peripheral end of the fan boss hole 4C is moved in the rotation direction R so as to coincide with the peripheral position of the blade rear edge 32.

On the other hand, the fan boss hole 4C is formed so that an opening having a shape same as that of the fan boss hole 4A is located adjacent to the fan-blade 3 in an area between the blade front edge 31 and the blade rear edge 32, that is, on a side of the blade negative pressure surface 34 of the fan-blade 3. As it is possible to increase the magnitude of the negative pressure and the opening area at the forming position of the fan boss hole 4C, the air flow rate in the fan boss hole 4C can be also increased.

In the present embodiment, as any one of the above-described fan boss holes 4A to 4D can be used, the five selected type holes in total can be arranged in vicinity of the respective blades of the fan-blade 3.

Thus, when the fan boss 2 provided with the fan boss holes 4 rotates in accordance with the rotation of the electric motor 106, the axial flow type fan-blade 3 produces an air flow F in the rotating axis direction thereof. Due to the rotation of the fan boss 2, two kinds of forces are applied on the openings (air passages) of the fan boss holes 4.

In other words, as the negative pressure of the outside of the fan boss 2 becomes lower than that of the inside of the fan boss 2 in accordance with the peripheral velocity of the fan boss 2, this pressure difference between the inside and the outside creates an air flow from the inside to the outside. The air flow velocity is determined only by the peripheral velocity of the fan boss 2 regardless of the circumferential position of the fan boss holes 4 with respect to the fan-blade 3.

Another force is produced by the pressure difference, produced by the fan-blade 3, between the blade positive pressure surface 33 and the blade negative pressure surface 34. An air flow from the inside to the outside of the fan boss holes 4 is produced by forming the fan boss holes 4 in a negative pressure producing area where the negative pressure is produced. The air flow is varied in accordance with the factors such as an installing angle of the fan-blade 3 to the fan boss 2, the cross-sectional shape of the fan-blade 3, etc. and the arrangement position of the fan boss holes 4 with respect to the fan-blade 3.

Due to the combination of the two pressure difference, a strong air flow A is created from the inside of the fan boss 2 to the outside thereof through the fan boss holes 4. In accordance with the air flow passing through the fan boss holes 4, an air flow B flowing into the fan boss 2 from the positive pressure side ventilation port 107 in the fan boss 2 and is created by the axial air flow F of the fan boss 2, acts as a cooling air flow passing through the inside and the outside of the electric motor 106.

As described above, in the present embodiment, as the fan boss holes 4 are provided so that the fan boss hole 4 opens in the negative pressure producing area from the bottom surface 2a of the fan boss 2 to the vicinity of the blade negative pressure surface 34 of the fan-blade 3, a large pressure difference from the inside to the outside of the fan boss hole 4 is produced by the rotation of the fan boss 2 and the fan-blade 3 and it is possible to create a strong air flow A. As a result, it is possible to produce a cooling air flow in the electric motor 106 within the fan boss 2 at high ventilation air flow rate.

### Other Embodiments

In the above embodiments, an example in which the radial ventilation paths 11 provided in the rotor magnet 10 extend radially from the rotating center side and have a section, which opens onto the rotor surface 10a, that is, a groove-like shape is shown but the present invention is not limited to this.

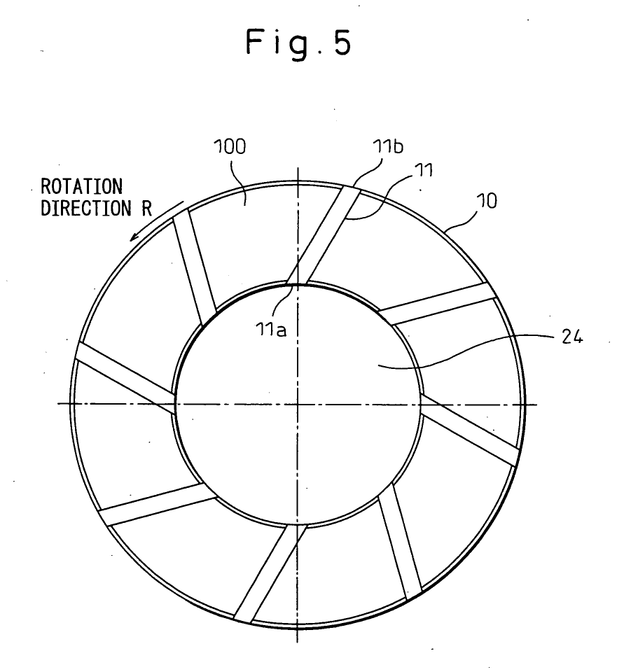

The rotor magnet may be formed, for example, as in an example shown in a plan view of the rotor magnet 10 in FIG. 5. In other words, the position of the outer peripheral side opening 11b of the groove 11 in the circumferential direction may be arranged so as to be more rear in the rotation direction R than the radial position of the rotating center side opening 11a. In this configuration, the peripheral velocity of the air flow in the outer circumferential side opening 11b can be increased so that the ventilation air flow rate can be increased by increasing the air speed in the radial groove 11.

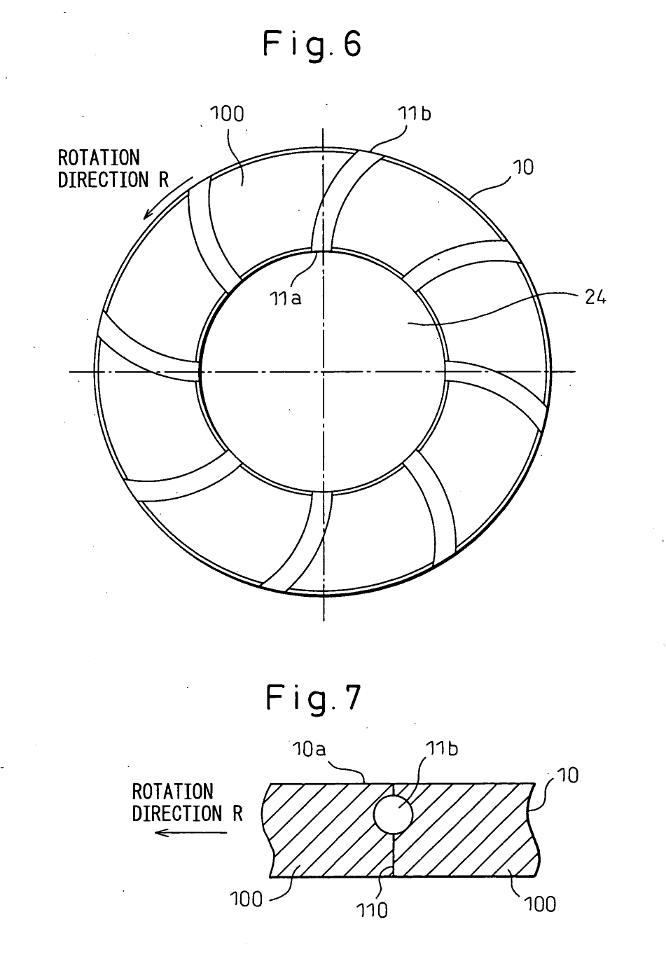

Alternatively, as shown in FIG. 6, in the plan view of the rotor magnet 10, the radial ventilation paths 11 may be a curved shape curved backward in the rotation direction R. Thus, the radial ventilation paths 11 need not to be exactly aligned with the rotating center axis in the radial direction as long as the radial ventilation paths 11 communicate the rotating center side space 24 with the outer circumferential side space 23 on the rotor surface 10a.

Furthermore, the above embodiments show the radial ventilation paths 11 having an open section, that is, a groove-like shape, which has an opening on the rotor surface 10a but the present invention is not limited to this. In other words, as shown in the elevational side view of the rotor magnet 10 in FIG. 7, an opening is not provided on the rotor surface 10a but a radial ventilation path 11 with a closed section may be formed so as to be buried along the boundary 110 of the two magnetic plates 100 in the rotor magnet 10. In this configuration, the air flow resistance is not increased during the rotation of the rotor magnet 10 and, similarly to the above embodiments, the air in the radial ventilation paths 11 is discharged to the outer circumferential side so that it is possible to increase the ventilation air flow rate in the fan boss 2.

While the invention has been described by reference to specific embodiments chosen for the purposes of illustration, it should be apparent that numerous modifications could be made thereto, by those skilled in the art, without departing from the basic concept and scope of the invention.

What is claimed is:

1. A fan motor comprising:
a stator;
a rotor rotating around a rotating shaft in accordance with an electric energy supplied from an outside in a state in which there is an air gap between the rotor and a plane surface of the stator;
a fan boss which includes a cylindrical member fixed to the rotating shaft of the rotor so that an axial direction of the fan boss is the same as an axial direction of the rotating shaft of the rotor, the fan boss accommodating the rotor and the stator in an inside of the cylindrical member;
a fan-blade integrally provided on an outer side surface of the cylindrical member of the fan boss and producing an air flow in the axial direction of the rotating shaft according to rotation of the rotor, wherein
a rotating center side space is provided around the rotating shaft of the rotor, an outer circumferential side space is provided between the rotor and an inner side surface of the fan boss at an outer circumferential side of the rotor and, at the same time, in the rotor, radial ventilation paths, which open to the rotating center side space at one end thereof, open to the outer circumferential side space at the other end thereof, respectively, and communicate the rotating center side space with the outer circumferential side space, are formed in parallel to a rotor surface opposing to the stator via the air gap; wherein
at least a ventilation outlet communicating the outer circumferential side space with an outside of the fan boss is provided in the fan boss; and wherein
communicating passages directed in a rotating axis direction and communicating the rotating center side space with a positive pressure side of the fan-blade in an air flow are provided in a rotating center side of the stator.

2. The fan motor as set forth in claim 1, wherein the radial ventilation path is a groove having an open side in a sectional shape thereof in which an opening is formed on a surface of the rotor.

3. The fan motor as set forth in claim 1, wherein the radial ventilation path has a sectional shape with closed sides.

4. The fan motor as set forth in claim 1, wherein at least the ventilation outlet is provided on a negative pressure side of the fan-blade in the air flow.

5. The fan motor as set forth in claim 4, wherein the opening area of the radial ventilation path in the axial direction of the rotating shaft is contained within an opening area of at least the ventilation outlet formed on a side surface of the cylindrical member of the fan boss, in the axial direction of the rotating shaft.

6. The fan motor as set forth in claim 1, wherein the rotor is formed so that a plurality of magnets are adjacently arranged with each other around the rotating shaft and, at the same time, each of the radial ventilation paths is formed along a boundary between two adjacent magnets.

7. The fan motor as set forth in claim 1, wherein each of the outer circumferential side openings of the radial ventilation paths is formed on a position radially corresponding to an opening of the radial ventilation path at the rotating center side or on a more rear position in the rotation direction with respect to a position of an opening of the radial ventilation path at the rotating center side.

8. The fan motor as set forth in claim 1, wherein a heat sink member, in which an outer periphery of the heat sink member forms a circumferential air gap between the outer periphery and an inner side surface of the fan boss is provided on a side of the stator opposite to the rotor;
a plane-like air passage is formed between the heat sink member and the stator and at the same time, a plurality of protrusions are provided so as to extend from the heat sink member to a stator side through the plane-like air passage; and
the plane-like air passage communicates with the circumferential air gap in the outer periphery and with the axial communicating passages of the stator in the rotating center side space.

9. A fan motor comprising:
a stator comprising armature coils;
a rotor opposing to the stator via an air gap formed in a radial direction and rotating around a rotating shaft in accordance with an electric energy supplied from an outside;
a fan boss which is a cylindrical member fixed to the rotating shaft of the rotor so that a an axial direction of the fan boss is the same as an axial direction of the rotating shaft of the rotor, the fan boss accommodating the rotor and the stator in an inside of the cylindrical member;
a fan-blade integrally provided on an outer side surface of the cylindrical member of the fan boss and producing an air flow in the axial direction of the rotation shaft according to rotation of the rotor, wherein
the stator is provided with through holes communicating a first surface, which opposes to the rotor so as to form the air gap, with a second surface on a side opposite to the rotor; and
at least a ventilation outlet communicating the air gap in vicinity of an outer circumferential side of the rotor with an outside of the fan boss is provided on the fan boss.

10. The fan motor as set forth in claim 9, wherein at least the ventilation outlet of the fan boss is formed on an area of the fan boss at an upstream side of the fan-blade in a direction of an air flow produced by the fan-blade.

11. The fan motor as set forth in claim 9, wherein openings of the through holes of the stator near the second surface communicate with a downstream area of the fan-blade in a direction of an air flow produced by the fan-blade.

12. The fan motor as set forth in claim 9, wherein each of the armature coils is formed by an empty core coil wound around the through hole.

13. The fan motor as set forth in claim 9, wherein a heat sink member is provided near the second surface of the stator;
a plane-like air passage is formed between the heat sink member and the second surface and at the same time, a plurality of protrusions are provided so as to protrude toward a side of the stator from the heat sink member through the plane-like air passage; and
the plane-like air passage communicates with a downstream area of the fan-blade.

14. A fan motor comprising:
an electric motor comprising a rotating shaft;
a fan boss a bottom surface of which is fixed to the rotating shaft so that an axial center of the fan boss coincides with a rotating axis of the rotating shaft, the fan boss accommodating the electric motor in an inside of a cylindrical member of the fan boss;
a fan-blade integrally provided on an outer side surface of a cylindrical member of the fan boss and producing an air flow in an axial direction of the rotation shaft by rotating together with the fan boss according to rotation of the electric motor so that the bottom surface is located at an upstream side in the air flow, wherein
at least a ventilation outlet communicating an inside and an outside of the fan boss is provided at an upstream side of the air flow produced by the fan-blade in the outer side surface of the cylindrical member of the fan boss.

15. The fan motor as set forth in claim 14, wherein at least the ventilation outlet opens so that an opening length of at least the ventilation outlet is distance from the bottom surface to an end portion in the axial direction of the rotating shaft.

16. The fan motor as set forth in claim 14, wherein at least the ventilation outlet opens so as to include a position of a maximum negative pressure producing portion at a blade negative pressure surface side in a blade root of the fan-blade, in the axial direction of the rotating shaft.

17. The fan motor as set forth in claim 14, wherein at least the ventilation outlet opens so as to include a maximum negative pressure producing portion at a blade negative pressure surface side in a blade root of the fan-blade.
